(19) United States
(12) Patent Application Publication
(10) Pub. No.: US 2008/0172888 A1
(43) Pub. Date: Jul. 24, 2008

(54) Molded plastic and metal combination cutting blade

(76) Inventors: John W. Long, Omaha, NE (US); Dale R. Ross, McPherson, KS (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 12/009,989

(22) Filed: Jan. 23, 2008

Related U.S. Application Data
(60) Provisional application No. 60/897,429, filed on Jan. 23, 2007.

(51) Int. Cl. A22C 17/04

(52) U.S. Cl. 30/276

(57) ABSTRACT

A blade support structure for a rotary knife blade includes a lower blade-engaging ring and an upper mounting section, the lower blade-engaging ring including a circumferential blade support channel operative to releasably rotatably secure and support a toroidal rotary knife therein. The blade support channel is constructed of material selected from the group consisting of plastic, polyvinyl chloride, polyethylene, polypropylene, polystyrene, vinyl, and polyethylene terephthalate when the upper blade holder engagement section of the toroidal rotary knife is constructed of metal, and the blade support channel is constructed of metal when the upper blade holder engagement section of a toroidal rotary knife is constructed of material selected from the group consisting of plastic, polyvinyl chloride, polyethylene, polypropylene, polystyrene, vinyl, and polyethylene terephthalate.

### CROSS-REFERENCE TO RELATED APPLICATION

This application claims priority to the filing date of related provisional patent application Ser. No. 60/897,429 filed on Jan. 23, 2007.

### BACKGROUND OF THE INVENTION

1. Technical Field

The present invention is directed to cutting blades for rotary knives and, more particularly, to a molded plastic and metal combination cutting blade which replaces the all-metal mounting structure and toroidal blades commonly used on defatting and boning knives in the meat packing industry, the molded plastic and metal combination cutting blade including two main elements, an upper mounting section and a lower blade portion, with respective ones of the two sections constructed of either impact-resistant plastic or metal such that the two sections are constructed of different materials yet function together to provide an improved combination cutting blade and mounting structure.

2. Description of the Prior Art

The meat packing and processing industry has become increasingly important as the world population continues to grow thereby increasing the need for meat and meat products. As a result of the increased demand for meat, the meat packing industry had to become more efficient in its meat processing and packing operations. Through the use of improved technology and “assembly-line” like operations, the meat industry has been able to increase the production of meat and meat products. However, the industry requires individuals to use some form of knife to remove bones and trim the excess fat from the meat. Accordingly, the meat packing industry has attempted to produce knives that allow the user to debone and trim meat faster, safer, and more economically; a long-felt-need which has yet to be fully addressed.

The prior art discloses knives that typically have a handle, a drive mechanism, and a blade. Although there are numerous types of powered knives which are used, one of the more commonly used types includes a circular blade which rotates at a high rate of speed, the blade being rotatably supported on a handle. These knives are used to remove and trim fat from the carcass by “planing” the knife over the area on the carcass which is being trimmed and the spinning of the blade cuts the tissue being contacted to remove a strip from the carcass. It has been found that these types of blades are very efficient at removing tissue from the carcass, but there are inherent problems with the use of these knives that have not been solved by the prior art.

One of these problems in the meat packing industry is the large amount of vibration and noise emitted by the rotary knives. The nature of the meat packing industry requires the blades to rotate at extremely high-speeds. To achieve the required speeds, knives of the prior art incorporate a drive mechanism consisting of a drive shaft and a gear which are composed of metal. The drive shaft would engage the gear and both the shaft and gear would spin to rotate the blade which is also made of metal along with the blade support ring. As a result, the metal-on-metal contact of the knife components operating at high-speeds would cause a high-pitched noise that could damage the eardrum and impair hearing. Additionally, the lack of a damper in the drive mechanism and high-speed operation causes severe vibration of the knife that could result in loss of control of the knife and injury to the user. While it is possible to reduce vibrations through the use of such a damping device, this does not completely solve the problem. Also, while this metal-on-metal contact of the drive mechanism and the knife blade holder continues to be a significant cause of vibration, an even more significant cause of the vibration is the metal-on-metal friction and contact between the blade and the blade support structure which rotatably supports the blade. There is therefore a need for a blade support structure which not only supports the blade but one that will reduce the noise and vibration rendering the rotary knife safer and more comfortable to use.

It should be noted that construction of a blade support structure out of materials other than metal has never been attempted due to the high speed of rotation of the rotary knife. Unless the structural integrity of the material can be guaranteed, there is the chance that the blade support structure will fracture and release the rotary knife, thus causing injury to the user of the knife. Furthermore, the material must be cost-effective to use in the blade support structure or it will not be useful to the industry. There is therefore a need for an improved, safe and cost-effective blade support structure that will resolve many of the problems currently encountered in the art.

Therefore, an object of the present invention is to provide an improved molded plastic and metal blade support structure for a rotary knife.

Another object of the present invention is to provide an improved molded plastic and metal blade support structure for a rotary knife that provides-a plastic-on-metal or metal-on-plastic interaction between the rotary knife blade and the blade support structure which significantly decreases the incidence of vibrational injury caused by use of the rotary knife equipped with the present invention.

Another object of the present invention is to provide an improved molded plastic and metal blade support structure for a rotary knife that significantly reduces the noise produced by the rotary knife during operation thereof.

Finally, it is an object of the present invention to provide an improved molded plastic and metal blade support structure for a rotary knife which is relatively simple and inexpensive to manufacture and is safe and efficient in use.

### SUMMARY OF THE INVENTION

The present invention is directed to a combination of a toroidal rotary knife which includes a rotary knife blade having a sharpened circular lower edge and an upper blade holder engagement section and a blade holder section engaging the rotary knife blade and including a generally toroidal blade holding ring having an upper gear-engaging section including a plurality of gear teeth formed thereon for intermeshing with a drive means and a lower blade engagement and retention section adapted to receive and retain the rotary knife blade therein. The generally toroidal blade holding ring is constructed of material selected from the group consisting of metal, plastic, polyvinyl chloride, polyethylene, polypropylene, polystyrene, vinyl, and polyethylene terephthalate.

A blade support structure includes a lower blade-engaging ring and an upper mounting section, with the lower blade-engaging ring including a circumferential blade support channel operative to releasably secure the generally toroidal blade holding ring of the blade holder section within the blade support channel whereby the blade-engaging ring releasably secures and supports the toroidal rotary knife therein with the toroidal rotary knife being rotatable within the blade support channel of the lower blade-engaging ring. Finally, the blade support channel, and likely the entire blade support structure, is constructed of material selected from the group consisting of plastic, polyvinyl chloride, polyethylene, polypropylene, polystyrene, vinyl, and polyethylene terephthalate when the generally toroidal blade holding ring is constructed of metal and the blade support channel is constructed of metal when the generally toroidal blade holding ring is constructed of material selected from the group consisting of plastic, polyvinyl chloride, polyethylene, polypropylene, polystyrene, vinyl, and polyethylene terephthalate.

The present invention as thus described has many advantages over those devices found in the prior art. The metal-on-plastic (and vice versa) frictional engagement between the blade support channel and the blade holding ring provides the dual advantage of long lifespan and a significant reduction in noise and vibration emission from the rotary knife. Furthermore, the construction materials used in connection with the present invention are relatively inexpensive and can easily be molded into the desired configurations, and can be done so to produce a safe and sturdy end product. Finally, the present invention, by ensuring a generally continuous metal-on-plastic interaction between the blade support channel and the blade holding ring, will further reduce noise and vibration of the rotary knife during use and therefore will help prevent injury to the knife users, thus rendering the invention far more efficient and safe for use than those devices found in the prior art. Therefore, the present invention is seen to provide substantial improvements over those devices found in the prior art.

### BRIEF DESCRIPTION OF THE DRAWINGS

FIG. 1 is a perspective view of the molded plastic and metal combination cutting blade of the present invention having a molded plastic upper section and lower metal blade portion;

FIG. 2 is a side detail elevational view of the embodiment of FIG. 1;

FIG. 3 is a perspective view of the molded plastic and metal combination cutting blade of the present invention having a metal upper section and lower molded plastic blade portion; and

FIG. 4 is a side elevational view of the embodiment of FIG. 3.

### DESCRIPTION OF THE PREFERRED EMBODIMENT

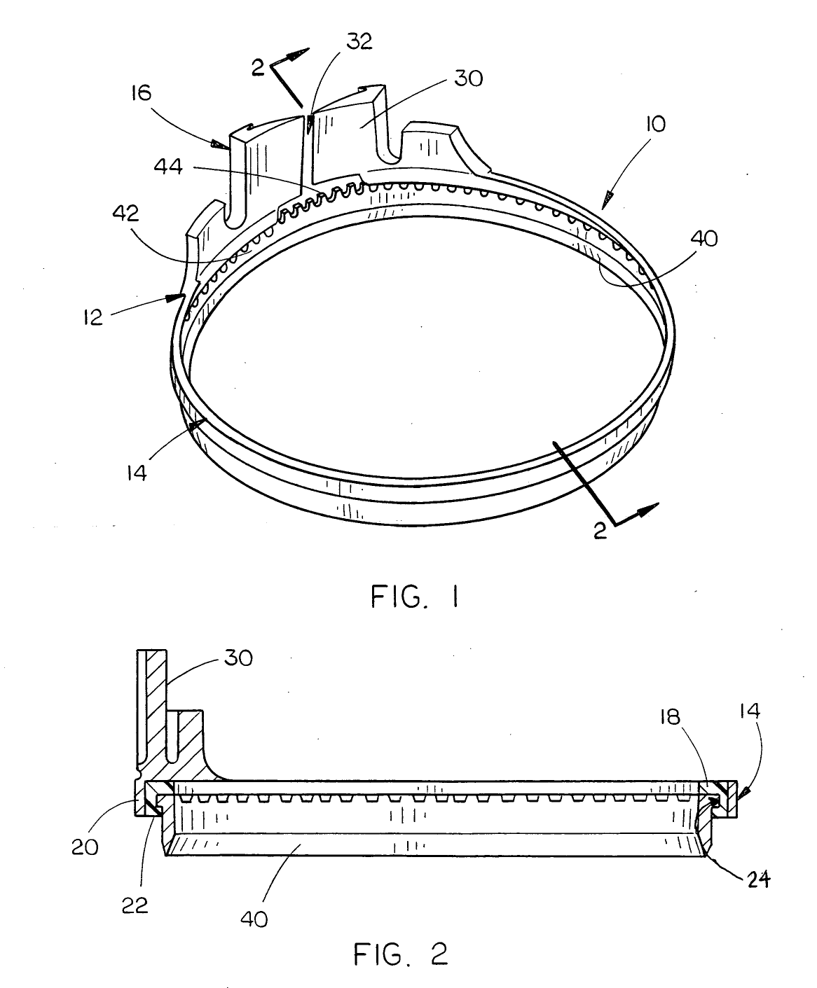

The molded plastic and metal combination cutting blade 10 of the present invention is shown best in FIGS. 1-4 as including a generally toroidal molded plastic blade support structure 12 which includes a lower blade-engaging ring 14 and an upper mounting section 16. In the preferred embodiment, the lower blade-engaging ring 14 would be constructed to include a top lip 18, sidewall 20 and lower lip 22 which together cooperate to form a blade support channel 24, as shown best in FIG. 2. It is preferred that the blade-engaging ring 14 have a diameter of approximately three to five inches and that the blade support channel 24 have dimensions which approximate the dimensions of the upper part of the blade 40 such that the upper portion 42 of blade 40 is releasably secured within the blade support channel 24 whereby the blade-engaging ring 14 releasably secures and supports the blade 40 therein with the blade 40 being rotatable within the blade support channel 24 of blade-engaging ring 14.

Mounted on and extending upwards from the blade-engaging ring 14 is upper mounting section 16 which, in the preferred embodiment, would include a boning knife engagement structure 30 which includes appropriate structural elements to fit within and be retained by the boning knife (not shown), which generally includes a receiving slot or channel into which the boning knife engagement structure 30 is slid to retain the plastic blade support structure 12 on the boning knife. Therefore, the boning knife engagement structure 30 may have any appropriate size and shape so long as it fits within and may be retained by the boning knife.

One of the critical features of the present invention however, is that the boning knife engagement structure 30 includes a slot opening 32 which extends vertically between the components of the boning knife engagement structure 30, and this slot opening 32 permits the opposite sides of the boning knife engagement structure 30 to be pulled apart to widen the slot opening 32. This, correspondingly, increases the diameter of the blade-engaging ring 14, and the blade 40 held within the blade support channel 24 is thus released from support thereby. The important and heretofore unavailable feature of the present invention is thus described and shown in that the blade 40 may be removed from the molded plastic blade support structure 12 by biasing apart the boning knife engagement structure 30 thus widening slot opening 32 and increasing the diameter of the blade-engaging ring 14. Once the blade 40 is removed from the blade-engaging ring 14, a new blade may be inserted into the blade-engaging ring 14 and due to the resiliency of the construction material used in connection with the molded plastic blade support structure 12, the blade-engaging ring 14 will return to its unbiased configuration as shown in FIG. 1 and the blade 40, specifically the upper portion 42 of blade 40, will be retained within the blade support channel 24 of blade-engaging ring 14. In this manner, blades may be quickly and easily substituted and replaced within the molded plastic blade support structure 12 which means that the user of the present invention need not discard the entire assembly each and every time the blade becomes worn, nicked or otherwise degraded in performance. This represents a substantial improvement over those devices found in the prior art.

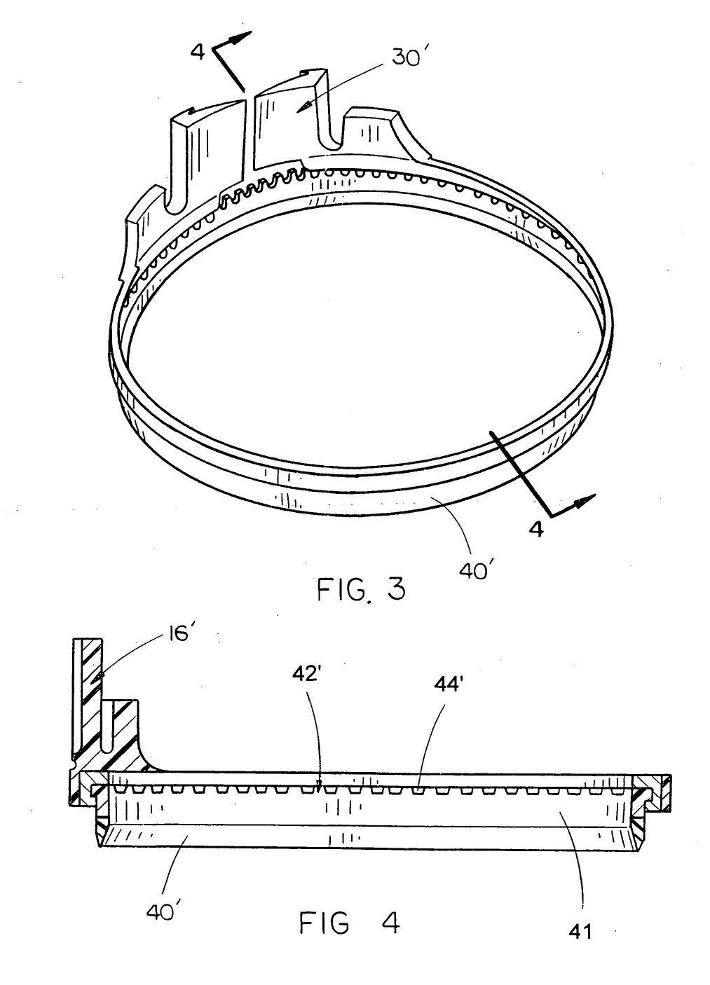

An alternative embodiment of the present invention is shown best in FIGS. 3 and 4 in which the plastic construction of the molded plastic blade support structure 12 has been replaced by a metal construction material 12′ and the blade 40′, constructed of metal in connection with the embodiment shown in FIGS. 1 and 2, is now constructed of a plastic material or a combined metal and plastic material as taught by applicant's previous invention disclosed in U.S. Pat. No. 6,880,249.

In this embodiment, the blade 40′ would include a sharpened circular lower edge and would be mounted in an upper blade holder engagement section 41, with the upper blade holder engagement section 41 further including an upper gear-engaging section 42′ including a plurality of gear teeth 44′ formed thereon for intermeshing with a drive means. The upper blade holder engagement section 41 would be constructed of plastic, while the blade 40′ would be constructed of metal, or vice-versa depending on the operational characteristics desired by the user of the present invention. However, should the upper blade holder engagement section be constructed of plastic, it is preferred that the plastic be selected from among the following plastic materials: polyvinyl chloride, polyethylene, polypropylene, polystyrene, vinyl, and polyethylene terephthalate. These high-impact plastics used in construction of the upper blade holder engagement section 41 interact with the drive gear of the boning knife, and this results in a much quieter and vibration-resistant intermeshing, thereby alleviating many of the problems found in the prior art. Of course, the number of gear teeth 44′ and exact size and shape will be dependent on the size and shape of drive gear and the particular boning knife to which the present invention is to be mounted.

In any event, the reversing of the construction materials used in connection with the blade support device 12′ and the blade 40′, specifically the upper blade holder engagement section 41, results in a functionality which is virtually identical to the embodiment disclosed in FIGS. 1 and 2, i.e. the metal-on-plastic interface, but there may be certain situations where use of a metal blade support structure 12′ is important for purposes of structural strength and longevity when used in connection with certain types of rotary boning knives. It is important to note, however, that in both embodiments, a critical feature is that the blade 40 and 40′ may be quickly and easily removed and replaced from the blade support structure 12 and 12′, and the fact that plastic is in frictional contact with metal and vice versa depending on the embodiment renders the present invention far superior to those metal on metal blade units found in the prior art. This is due to the fact that those metal-on-metal blades and blade support structures are extremely noisy and generate a great deal of vibration, which can result in increased chances for hearing damage and bodily injury to the person using the device. Furthermore, because of the high-speed rotation of the blade in the prior art, the resulting noise is high-pitched in frequency, thus exacerbating the potential hearing damage. It has been found that the metal-on-plastic frictional contact found in the present invention will greatly reduce the noise and vibration produced when compared with the metal-on-metal devices found in the prior art, and it is therefore believed that the metal-on-plastic contact of the blade support structure 12 and 12′ and blade 40 and 40′ as disclosed in the embodiments of FIGS. 1 and 2 and the embodiment of FIGS. 3 and 4 is superior to and not suggested by the prior art.

It should also be noted that the gear teeth 44 formed on the upper portion 42 of blade 40 would preferably mesh with the drive gear of the boning knife in which the present invention is mounted, due to the particular size, shape and construction configuration used in connection with blade support structure 12. Such modifications and adjustments in configuration would be understood by one skilled in the art of boning knives.

It therefore is to be understood that numerous modifications, additions and substitutions may be made to the molded plastic and metal combination cutting blade 10 of the present invention which fall within the intended broad scope of the above disclosure. For example, the size, shape and dimensions of the device may be modified or changed to fit various-sized and configured boning knives which are used in the meat packing industry, as the intended function of reducing vibration, reducing noise pollution, and permitting quick and easy replacement and reinstallation of blades in the blade support structure 12 will be maintained. Also, the exact configuration of the boning knife engagement structure 30 may be modified or changed so long as the mounting of the blade support structure 12 within the boning knife is secure and generally prevents accidental dislodging of the blade support structure 12 from the boning knife. Also, although the plastic material used for construction of the elements of the present invention is expected to be selected from the group consisting of plastic, polyvinyl chloride, polyethylene, polypropylene, polystyrene, vinyl and polyethylene terephthalate, any appropriate construction material may be used in connection with the present invention which is drawn from the plastic family so long as the combination of metal and plastic construction materials described above is maintained. Finally, although it is preferred that the plastic pieces of the present invention would be constructed through injection molding and the metal pieces be constructed through any of the various metal molding processes known, the precise method of construction is not critical to the present invention so long as the blade support structure 12 and blade 40 are functionally competent and able to function correctly when installed on a rotary boning knife.

There has therefore been shown and described a molded plastic and metal combination cutting blade 10 for a rotary boning knife which accomplishes at least all of its intended objectives.

We claim:

1. In combination:
a toroidal rotary knife including a rotary knife blade having a sharpened circular lower edge and an upper blade holder engagement section, said upper blade holding engagement structure being constructed of material selected from the group consisting of metal, plastic, polyvinyl chloride, polyethylene, polypropylene, polystyrene, vinyl, and polyethylene terephthalate; and
a blade support structure including a lower blade-engaging ring and an upper mounting section;
said lower blade-engaging ring including a circumferential blade support channel operative to releasably secure said upper blade holder engagement section of said toroidal rotary knife within said blade support channel whereby said lower blade-engaging ring releasably secures and supports said toroidal rotary knife therein with said toroidal rotary knife being rotatable within said blade support channel of said lower blade-engaging ring;
said blade support channel being constructed of material selected from the group consisting of plastic, polyvinyl chloride, polyethylene, polypropylene, polystyrene, vinyl, and polyethylene terephthalate when said upper blade holder engagement section of said toroidal rotary knife is constructed of metal; and
said blade support channel being constructed of metal when said upper blade holder engagement section of said toroidal rotary knife is constructed of material selected from the group consisting of plastic, polyvinyl chloride, polyethylene, polypropylene, polystyrene, vinyl, and polyethylene terephthalate.

2. The combination of claim 1 wherein said blade support structure is constructed generally entirely of the same material used in construction of said blade support channel thereby forming an integral unit.

3. In combination:
a toroidal rotary knife including;
a rotary knife blade having a sharpened circular lower edge and an upper blade holder engagement section;
a blade holder section engaging said rotary knife blade and including a generally toroidal blade holding ring having an upper gear-engaging section including a plurality of gear teeth formed thereon for intermeshing with a drive means and a lower blade engagement and retention section adapted to receive and retain said rotary knife blade therein;
said generally toroidal blade holding ring being constructed of material selected from the group consisting of metal, plastic, polyvinyl chloride, polyethylene, polypropylene, polystyrene, vinyl, and polyethylene terephthalate; and
a blade support structure including a lower blade-engaging ring and an upper mounting section;
said lower blade-engaging ring including a circumferential blade support channel operative to releasably secure said generally toroidal blade holding ring of said blade holder section within said blade support channel whereby said blade-engaging ring releasably secures and supports said toroidal rotary knife therein with said toroidal rotary knife being rotatable within said blade support channel of said lower blade-engaging ring;
said blade support channel being constructed of material selected from the group consisting of plastic, polyvinyl chloride, polyethylene, polypropylene, polystyrene, vinyl, and polyethylene terephthalate when said generally toroidal blade holding ring is constructed of metal; and
said blade support channel being constructed of metal when said generally toroidal blade holding ring is constructed of material selected from the group consisting of plastic, polyvinyl chloride, polyethylene, polypropylene, polystyrene, vinyl, and polyethylene terephthalate.

4. The combination of claim 1 wherein said blade support structure is constructed generally entirely of the same material used in construction of said blade support channel thereby forming an integral unit.

5. A blade support structure for a rotary knife blade comprising:
a lower blade-engaging ring and an upper mounting section;
said lower blade-engaging ring including a circumferential blade support channel operative to releasably secure an upper blade holder engagement section of a toroidal rotary knife within said blade support channel whereby said lower blade-engaging ring releasably secures and supports a toroidal rotary knife therein with a toroidal rotary knife being rotatable within said blade support channel of said lower blade-engaging ring;
said blade support channel being constructed of material selected from the group consisting of plastic, polyvinyl chloride, polyethylene, polypropylene, polystyrene, vinyl, and polyethylene terephthalate when the upper blade holder engagement section of a toroidal rotary knife is constructed of metal; and
said blade support channel being constructed of metal when the upper blade holder engagement section of a toroidal rotary knife is constructed of material selected from the group consisting of plastic, polyvinyl chloride, polyethylene, polypropylene, polystyrene, vinyl, and polyethylene terephthalate.
